(19) United States
(12) Patent Application Publication
(10) Pub. No.: US 2016/0307649 A1
(43) Pub. Date: Oct. 20, 2016

(54) APPARATUS AND PROCESS FOR PENETRATION OF THE COULOMB BARRIER

(71) Applicant: Azaroghly Yazdanbod, Calgary (CA)

(72) Inventor: Azaroghly Yazdanbod, Calgary (CA)

(21) Appl. No.: 15/135,291

(22) Filed: Apr. 21, 2016

Related U.S. Application Data
(63) Continuation-in-part of application No. 13/870,239, filed on Apr. 25, 2013, now abandoned.
(60) Provisional application No. 61/638,161, filed on Apr. 25, 2012.

(51) Int. Cl. G21B 1/05; G21B 1/17; G21B 1/21

(52) U.S. Cl. CPC G21B 1/05; G21B 1/21; G21B 1/17

(57) ABSTRACT

A device and method for penetrating the Coulomb barrier is disclosed. An electrode is positioned within a hollow shell, the shell enclosing an inner space containing a fusion reactive fuel. The inner space with the fuel surrounds the electrode, and a confinement layer made of a high dielectric strength and high dielectric constant material is located on the inside surface of the hollow shell. A high voltage power source charges the electrode, which causes a tightly packed fusion fuel nuclei cloud such as a deuteron cloud to form on the confinement layer, facilitating the elimination of Coulomb repulsive forces between nuclei, such that ions fired towards the nuclei cloud can fuse with nuclei in the cloud.

### CROSS-REFERENCE TO RELATED APPLICATIONS

This application is a continuation-in-part of U.S. application Ser. No. 13/870,239 filed Apr. 25, 2013, which claims the benefit of U.S. Provisional application No. 61/638,161 filed Apr. 25, 2012, the disclosures of which are incorporated herein by reference in their entirety.

### FIELD OF THE INVENTION

The present invention relates generally to energy generation, and more specifically to energy generation by capacitive confinement of ions for penetration of the Coulomb Barrier.

### BACKGROUND OF THE INVENTION

Scientists have long dreamed of a method of producing an unlimited source of energy through controlled fusion, wherein mass is converted into energy via the famous equation E=MC². Nuclear fusion generally combines small, light nuclei to form heavier nuclei, wherein the mass of the reaction products is less than the mass of the reactants, with the difference in mass being converted to large amounts of energy. It is postulated that when the temperature of such reactants, such as deuterium and tritium gases, are raised to several million degrees Kelvin, the gas atoms can be stripped of their electrons and gain such a kinetic energy that their collisions results in nuclear fusion. This premise is being put to the test under such approaches as magnetic confinement and inertial (laser) confinement. In these approaches the reactants are heated to a plasma state and prevented from contacting the reaction chamber walls by various means as magnetic confinement to maintain the temperature and prevent damage to the chamber.

Another approach to nuclear fusion is based on accelerating the individual nuclei to high speeds and colliding them. These include various so called fusers such as Farnsworth-Hirsch fusor, in which high intensity electric fields generated between two concentric spherical electric grids are used to ionize and accelerate the reactants. Another such approach involves the use of neutron generators, in which an electric field is established between an anode and a cathode, where the cathode is a metal hydride part used as a target. Reactant gases are ionized near the anode and are fired at deuterium- or tritium-rich metal hydride target, resulting in fusion of the reactants. All of these approaches have been shown to result in fusion reactions, evidenced by production of fusion products such as neutrons; however, all of these suffer from low yield.

Many very innovative neutron generator designs, such as spherical and cylindrical designs, have been put to practice. A case in point is U.S. Pat. No. 7,139,349 issued to Leung, in which the anode is in the shape of hollow sphere, firing ions at a target at the center of the anode. There are also designs that use a gas between the anode and the cathode as the target, such as described in U.S. Pat. No. 6,922,455 issued to Jurczyk, et al. All such devices suffer from limited operational temperature of the target as it loses entrapped hydrogen isotopes when heated and from electron discharge from neutral atoms. The typical maximum operating temperature for metal hydride targets is typically cited to be less than 200 degrees Celsius.

Although fusion reactions do take place in devices referred to as neutron generators, they are generally not regarded as energy-generating devices due to their low yield. Higher yield devices, such as described in U.S. Pat. No. 8,090,071 to DeLuze, discloses a spherical fusion reactor with a charged central target electrode which uses an alternating polarity electric field to accelerate electrons and deuterium nuclei back and forth. DeLuze teaches that the ions gain such speed that their collisions with each other result in fusion.

While known methods and devices for creating fusion reactions may be useful for their intended purposes, there currently is no device or method for capacitive high density confinement of ions for use as targets for beam-on target systems. It would therefore be beneficial to target capacitively confined ions with high temperature stability and without electrons, such ions being fired upon by other charged nuclei with high current density, as a means of effecting fusion reactions. It would also be advantageous to provide a capacitive manipulation mechanism for confining charged nuclei at high concentrations and in relatively close proximity to one another, forming a conductive layer in a closed insulated container to provide an environment in which the repulsive Coulomb forces in the container are highly reduced or eliminated. Further, it would be beneficial to use ionizing radiation to ionize fusion fuel gases to reduce the amount of energy needed for forming ions that could then be capacitively confined as a target or could be accelerated towards the target from the interior of the device to fuse with the target ions without experiencing the Coulomb Barrier. It would also be beneficial to utilize the quantum tunneling phenomena known in quantum mechanics to affect a controlled and measured rate of reaction.

### SUMMARY OF THE INVENTION

Accordingly, the present invention generally relates to an apparatus and process for confinement and concentration of positively charged nuclei (e.g. deuteron nuclei) for use as targets to be fired upon by other ions that are generated and accelerated towards this target from the interior of the capacitively confined target. U.S. Pat. No. 8,715,477 and U.S. Pat. No. 9,309,133, both to the present inventor Yazdanbod, and both incorporated herein by reference in their entirety, specifically teach electric double layer capacitors, behavior of high and low electric capacitance electrodes in confined containers, use of high electric capacitance electrodes as means of capacitive generation of electric fields, and polarity reversals as means of avoiding electrode reactions at metallic electrodes for the same. Experimental evidence and test results establishing the formation and voltage distribution of Electric Double Layer Capacitors and formation of capacitively confined ions on dielectrics as inspirational foundations of the present invention are emphasized.

As used herein the term “dielectric” means any insulating material or poor conductor of electricity that polarizes in response to an electric field without release of electrons. The phrase “high dielectric constant” means dielectric constants greater than 300, preferably greater than 2000 and more preferably greater than 10,000. The phrase “high dielectric strength” means a dielectric strength greater than 0.5 MV/m, preferably greater than 1.0 MV/m and more preferably greater than 2.0 MV/m. The phrase “high electric potential” means an electric potential great enough to create an electric field capable of ionizing a gas at a given pressure or to propel generated ions towards a target. The term “dielectric charging factor” or “DCF” means the product of dielectric constant and dielectric strength. Dielectrics with a high DCF are able to provide higher charge densities when charged to their maximum dielectric strength. As an example, Pyrex glass is assumed to have a dielectric constant of 4.7 and a dielectric strength of 14 MV/m. The DCF for Pyrex glass would then be 65.8 MV/m. In comparison Strontium Titanate is assumed to have a dielectric constant of 310 and a dielectric strength of 8 MV/m and a DCF of 2480 MV/m. This parameter allows for easier comparison of the usefulness of such materials for creating higher ion charge densities on dielectrics.

A first aspect of the invention provides an apparatus for penetrating the Coulomb Barrier, comprising: (a) an electrode; (b) a hollow shell enclosing an inner space around the electrode; (c) a confinement layer made of a material having a high dielectric strength and a high dielectric constant, the confinement layer located on the inside surface of the hollow shell, the inner space located between the confinement layer and the electrode; (d) a fusion reactive fuel contained within the inner space; (e) a high voltage electric power source capable of imposing alternating electric potentials with various wave shapes with and without direct current offset; (f) electrical interconnections for connecting the electric power source to the electrode and the shell to the earth ground; (g) passages for directing the fusion reactive fuel into and out of the hollow shell; (h) a fusion reactive fuel supply system; and (i) a vacuum pump system which would also include vacuum measurement gauges. Typically the electrode, the inner space, the confinement layer and the hollow shell could be spherical, with the electrode being centered within the shell.

A second aspect of the invention provides a method of confining nuclei for the purpose of reducing or eliminating the Coulomb barrier near the interior of a container, the method comprising: (a) providing a confinement layer made of a material having a high dielectric strength and a high dielectric constant, the confinement layer located on the inside surface of a hollow shell, the hollow shell enclosing an inner space around an electrode, the inner space located between the confinement layer and the electrode; (b) filling the inner space with a fusion reactive fuel; (c) charging an electrode seated within the inner space with a high voltage electric power source capable of imposing alternating electric potentials with various wave shapes with and without direct current offset, wherein the hollow shell both encloses the inner space and is centered about the electrode, wherein charging of the electrode causes a cloud of positively charged nuclei to form on the confinement layer; and (d) firing other charged nuclei at the cloud of positively charged nuclei on the confinement layer, wherein the other charged nuclei are generated and propelled towards the confinement layer by an electric field generated by the charged electrode. The electrode, the hollow shell, the confinement layer and the inner space could be in any shape meeting the requirements of the intended process, including spherical and cylindrical shapes.

A third aspect of the invention provides an apparatus for generation and capacitive confinement of charged nuclei as a means of overcoming the Coulomb Barrier, comprising: (a) a metallic electrode; (b) a multi-layered, hollow, metallic shell enclosing an inner space around the electrode, wherein the shell includes a confinement layer made of a material having a high dielectric strength and a high dielectric constant, the confinement layer located on the inside surface of the shell, the inner space located between the confinement layer and the electrode; (c) an electrically insulated support fixedly suspending the electrode within the shell; (d) a fusion reactive fuel contained within the inner space; (e) a high voltage electric power source capable of imposing alternating electric potentials with various wave shapes with and without direct current offset; (f) electrical interconnections for connecting the electric power source to the electrode and the shell to the earth ground; (g) at least one passage for directing the fusion reactive fuel into and out of the hollow shell; (h) at least one passage for directing ionizing radiation into the inner space; (i) an ionizing radiation source for each of the at least one ionizing radiation passage; (j) a fusion reactive fuel supply system; and (k) a vacuum pump system comprising vacuum measurement gauges.

The nature and advantages of the present invention will be more fully appreciated from the following drawings, detailed description and claims.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 illustrates a schematic perspective view of one embodiment of the invention.

FIG. 2 illustrates the charge distribution within the embodiment shown in FIG. 1 during charging of the electrode.

FIG. 3 illustrates a two cell embodiment for charging one cell by ions generated in the other cell

FIG. 4 illustrates an embodiment that uses an ionizing radiation source to ionize the fuel gas.

FIG. 5 is a graph showing one potential wave shape pulses of high voltage administered over time in order to generate and accelerate nuclei towards the confinement layer, according to the invention.

### DETAILED DESCRIPTION OF THE INVENTION

The present invention provides an apparatus and method for creating a target by confinement of positively charged nuclei (e.g. deuteron nuclei) in a dielectric container, thereby forming an ion cloud or sheath as the target. The cloud or sheath of ions so confined in the dielectric container can form a charged conductive layer. This charged conductive layer can lead to the reduction and elimination of the Coulomb barrier towards the interior of the container. That is, the charges within the ion cloud will create electric fields towards the outside of the cloud, such that there is no electric field towards the interior of the container. This charged conductive layer can be fired upon by other nuclei which have been generated and accelerated towards it from the inside of the container, in order to overcome the Coulomb barrier.

The Coulomb barrier is an energy barrier resulting from electrostatic interaction that two nuclei must overcome in order to approach close enough to undergo nuclear fusion. The Coulomb barrier is produced by electrostatic potential energy. In the fusion of light elements to form heavier ones, the positively charged nuclei must be forced close enough together to cause them to fuse into a single heavier nucleus. The force between nuclei is repulsive until a very small distance separates them, and then it rapidly becomes very attractive. Therefore, in order to surmount the Coulomb barrier and bring the nuclei close together where the strong attractive forces operate, the energy of the particles must overcome the repulsive energy of the Coulomb barrier.

In general, the present invention discloses fusion of positively charged nuclei, accomplished by 1) the creation of a high charge density ion layer or sheath on an insulating surface as the target, and 2) ions fired from the interior of the confinement layer towards the target ion layer. This insulating surface is herein termed as the confinement layer, or a fusion reaction layer. The electric fields needed to ionize the fuel gas to form the ion layer and to fire other ions towards it are created through high potential charging of a conductive or capacitive electrode placed inside an externally grounded conductive container. The container is internally lined with this dielectric (confinement) layer, the confinement layer having a high dielectric charging factor (DCF). Confinement of positively charged nuclei on the confinement layer results in increased charge density at the same potentials compared to free space formation of the same nuclei layer, to the extent needed for fusion reactions to take place as the electric fields and the Coulomb barrier in the direction towards the interior of the container is reduced and/or eliminated. Further, the confined nuclei can be a target for similar nuclei, which can be generated and accelerated from the nearby electrode in the interior by ionizing the gas in the interior of the container towards the ion layer. The space between the electrode and internal lining (confinement layer) can be filled to the extent needed with fusion fuel such as deuteron gas.

As noted above, for two nuclei to fuse, the repulsive Coulomb barrier must be overcome, which occurs when two nuclei are brought close enough together where the short-range “nuclear forces” become strong enough to overcome the Coulomb force and fuse the nuclei. This energy barrier between two unconfined positive charges can be defined by the electrostatic potential energy:

$${U}_{coul} = k \frac{{q}_{1} {q}_{2}}{r} = \frac{1}{4 {πε}_{0}} \frac{{q}_{1} {q}_{2}}{r} \qquad ( Equation 1 )$$

Where k is the Coulomb's constant=8.9876×10⁹ N m² C⁻²; ε₀ is the permittivity of free space; q₁, q₂ are the charges of the interacting particles; r is the interaction radius. A positive value of U is due to a repulsive force, so interacting particles are at higher energy levels as they get closer. A negative potential energy indicates a bound state (due to an attractive force).

Coulomb's barrier increases with the atomic numbers (i.e. the number of protons) of the colliding nuclei:

$${U}_{coul} = \frac{{kZ}_{1} {Z}_{2} {e}^{2}}{r} \qquad ( Equation 2 )$$

where e is the elementary charge (1.602 176 53×10⁻¹⁹ C) and Z₁ and Z₂ are the corresponding atomic numbers.

The force between nuclei is initially repulsive, due to the Coulomb forces, until a very small distance separates them, and then it rapidly becomes very attractive when the strong nuclear force takes over. Therefore, in order to surmount the Coulomb barrier, nuclei must get close enough for the attractive interaction between them to overcome the forces of repulsion, allowing the nuclei to bind or fuse together. Although there are many processes that could potentially lead to fusion of atomic nuclei, such as what happens due to huge gravitational forces in the sun, this can also be accomplished when the kinetic energy of the approaching nuclei overcomes the electrostatic repulsion of the Coulomb barrier as observed in such devices as neutron generators. In reality, the situation is helped by effects associated with quantum mechanics. Because of the Heisenberg Uncertainty Principle, even if the particles do not have enough energy to overcome the Coulomb barrier or get close enough, there is a very small probability that a few of the particles pass through the barrier anyway. This is called barrier tunneling, and is the means by which many such reactions take place at the rates observed, in stars including our sun. If barrier tunneling was absent, such stars would either not shine or would explode.

The terms “quantum mechanical tunneling”, “quantum tunneling”, “barrier penetration” or “barrier tunneling” as used herein each refer to the quantum mechanical phenomenon in which a particle (e.g. a nucleus) burrows or passes through a barrier that it classically could not surmount. For example, in classical physics an electron is seen as a particle that is repelled by an electric field as long as the energy of the electron is below the energy level of the electric field. However, in quantum physics this electron is known to have a finite probability of passing through the electric field. This phenomenon is used, for example, in the resonant tunneling diodes utilized in many electronic devices where fast acting diodes are needed. Quantum tunneling is one of the defining features of quantum mechanics and the wave-particle duality of matter.

To explain the scientific basis of the present invention, some basics of capacitor science should also be highlighted. A conventional electric capacitor is an electric energy storage device made up of two electrically conductive plates, or electrodes, separated by a dielectric. As defined herein, the term “dielectric” means an electrical insulator that can be polarized by an applied electric field. When a dielectric is placed in an electric field, electric charges do not flow through the material, as in a conductor, but only slightly shift from their average equilibrium positions causing dielectric polarization. If a dielectric is composed of weakly bonded molecules, those molecules not only become polarized, but also reorient so that their axis of symmetry aligns with the field.

Capacitors are commonly used in a variety of electrical applications. For example, capacitors are used to tune the frequency of radio and television receivers, to eliminate sparking in automobile ignition systems, as energy storing devices, in electronic flashing units, and as filters in power supplies. The common capacitor functions on the basis of removal of electrons from a first electrode, resulting in the reverse phenomena of placement of electrons on the other electrode. This charge separation leads to a potential difference between electrodes and storage of electric energy by the capacitor.

The amount of capacitance of a capacitor is dependent upon the surface area of the electrodes, the distance separating the electrodes, and the permittivity of the dielectric separating the electrodes. A capacitor can have a variety of geometric constructions. A parallel plate capacitor, for example, is a capacitor in which the electrodes thereof are parallel plates separated by a dielectric having both a thickness and a permittivity selected to control the amount of capacitance of the capacitor. A cylindrical capacitor is a capacitor in which one of its electrodes is a first cylindrical hollow tube and another of its electrodes is a second cylindrical (and typically but not necessarily also hollow) tube concentric with the first cylindrical hollow tube. A spherical capacitor has one electrode in the form of a hollow sphere surrounding another electrode in the form of a solid or hollow sphere. The volume between the hollow sphere and the inner sphere contains a dielectric having a thickness and a permittivity selected to control the capacitance of the spherical capacitor. Dielectrics between the plates of capacitors could be made up of one or a number of materials.

The Capacitance (C) of a capacitor in units of Farad is defined as the ratio of the amount of charge (Q) in units of Coulomb placed on or removed from each of the electrodes, to the potential difference (V) in units of Volts (Joules/coulomb) between electrodes, or:

C=Q/V (Equation 3)

Here it is also noted that when a positive charge is brought near a negative charge, its electrical potential is reduced from a higher value to a lower value. Also, when a negative charge is brought near a positive charge its potential increases from a lower value to a higher value. This means that as positive and negative charges are brought closer to each other, the potential difference between them is reduced. This is the underlying definition of capacitance as presented in Equation 3, which also shows that for a constant value of charge Q, any increase in capacitance will result in reduction of the potential difference (V) between capacitor plates.

This phenomenon is easily observed when a capacitor is charged to a certain potential difference between its plates, resulting in placement of a given amount of charge on each plate. Now, if the potential supply source is disconnected and the plates are brought closer to each other, it is easy to measure the decrease in potential difference between the two plates as the plates are moved closer to one another. Thus, as noted above for Equation 3, when the opposing charges on the two plates are moved closer to each other by reducing the distance between the plates, the potential difference (V) between plates for the fixed value of charge (Q) is reduced, as the capacitance (C) is increased.

Electrical capacitance is a function of capacitor geometry, electrode plate material and the permittivity of the dielectric material between the two electrode plates. Capacitance increases with larger plate sizes, smaller distance between plates, higher permittivity of the dielectric material, and the use of higher surface area electrode materials. Therefore, when a capacitor is charged by a constant potential difference applied between its two plates, and if a dielectric with a higher dielectric constant is then placed between these plates or if the two plates are brought closer to each other, then the capacitance and the amount of charge on each plate increases. This means that at a constant potential (in energy per unit charge) the charge density is increased when the capacitance is increased. This is why historically capacitors were referred to as charge condensers.

Dielectric breakdown results in a spark of electricity passing from one electrode to the other (through the dielectric) as the charge stored on the plates is released. Before the occurrence of dielectric breakdown, if the dielectric is a solid, then the action of the electric field generated between the capacitor plates causes the displacement of centers of positive and negative charges in the electrically neutral dielectric. In the present invention, one dielectric that can be used is deuterium. The nucleus of deuterium, called a deuteron, contains one proton and one neutron, whereas the far more common hydrogen isotope, Protium, has no neutron in the nucleus. Protium accounts for more than 99.98% of all naturally occurring hydrogen in Earth's oceans.

In accordance with one aspect of the invention, the dielectric between capacitor plates can be an elemental gas such as hydrogen or deuterium gas, instead of a solid. When such a gas dielectric is used, charging of the capacitor plates causes partial polarization of individual hydrogen atoms, such that there is weak alignment of these atoms in the direction of the electric field. However due to random thermal motion of these gas particles, this alignment is not complete. With increased electric field intensity, caused by increasing the potential difference between capacitor plates, the polarization and the consequent alignment increase. Once the dielectric strength of the hydrogen gas is reached, the bond between the electrons and the protons in the hydrogen atoms break and a spark is observed. This spark is the movement of negatively charged electrons from some of the hydrogen atoms towards the positively charged plate and the movement of the positively charged hydrogen nucleus (protons) towards the negatively charged plate of the capacitor. Upon contact with the negative electrode, the protons gain an electron and reconstitute the hydrogen atom and the electrons are absorbed by the positively charged plate. This process results in a resistive electric circuit allowing for flow of electricity by ionized gas particles between capacitor plates. If the potential difference between capacitor plates is reduced so that the electric field between plates could no longer ionize the gas, the flow of electricity stops.

The amount of energy stored in a capacitor is directly proportional to the amount of charge and the potential difference between plates. If the energy stored in a capacitor is designated as (U) in units of Joule, then:

U=(0.5)(Q)(V) (Equation 4)

The parameters and units are as defined earlier. Further it is noted that when two capacitors with capacities “C1” and “C2” are placed in series, the equivalent capacitance, or “Ceq” of the two connected capacitors, is defined by:

1/Ceq=1/C1+1/C2 (Equation 5)

This equation shows that when two capacitors are placed in series, the equivalent capacitance is effectively controlled by the capacitor having the lower capacitance. Further, because the amount of charge placed on two capacitors in series (herein denoted as “q”) are equal, the potential difference between the plates of such individual capacitors denoted as “V1” and “V2” , based on Equation 3 are defined as:

V1=q/C1 (Equation 6)

and

V2=q/C2 (Equation 7)
and therefore;

V1/V2=C2/C1 (Equation 8)

The total potential difference across the two capacitors connected in series is herein denoted as V is:

V=V1+V2 (Equation 9)

The above equations and particularly Equation 8 clearly indicate that when a capacitor with a very large capacitance is connected in series with another capacitor with very small capacitance, most of the potential difference applied across the two capacitors will occur across the capacitor with smaller capacitance.

Further, it is noted that a single conductive body could also be viewed as a capacitor, assuming that the second plate is located at infinity. As an example, a single spherical conductor in free space has a capacitance of:

C=4Πεₒr (Equation 10)

where ε₀ is the permittivity of free space, equal to 8.854E−12 Farads per meter, and ‘r’ is the radius of the sphere in meters. Here it is noted that that if the single isolated spherical conductor is fully immersed in a dielectric with dielectric constant of k, then the permittivity term ε₀ in equation 10 is replaced by K ε₀ indicating a proportional increase in capacitance.

Another physical phenomenon considered here is “barrier tunneling” as defined above. In combination with the capacitive confinement of ions and nuclei as described herein, leading to the formation of a conductive ion layer on the inner surface of the confinement layer, in turn leading to reduction or elimination of electric fields towards the interior of the said container and thus defining a target for other ions fired towards this layer from the interior of the container to more easily penetrate the coulomb barrier, barrier tunneling and the wave-particle duality of matter may provide for a few nuclei out of many to penetrate the coulomb barrier of another, even though the requisite energy level is less than the given barrier height. In such a situation, the probability of barrier tunneling (i.e. the odds of any given positively charged nucleus penetrating the coulomb barrier of another positively charged nucleus) is a function of particle mass, barrier width and the energy difference between the barrier height and particle energy. For a proton that is electrostatically forced towards another proton, with all other parameters being constant, then the difference between the energy of the proton and the energy needed to overcome the Coulomb barrier governs the probability of barrier tunneling. Therefore, the number of protons passing through the barrier in a given time span would be governed by the energy difference between each proton and the Coulomb barrier. In the present invention, it is proposed that the probability of Coulomb barrier penetration is increased by formation of a target made up of ions that are capacitively confined on the interior surface of the confinement layer containing them, and leading to a lowering of and eventual penetration of the Coulomb barrier for ions fired towards it from the inside. In practical terms, because of barrier tunneling phenomena, fusion reactions could occur at larger distances than perfect touching of the two nuclei concerned or the size of the interacting particles for fusion reactions could be assumed and will be larger than their physical size.

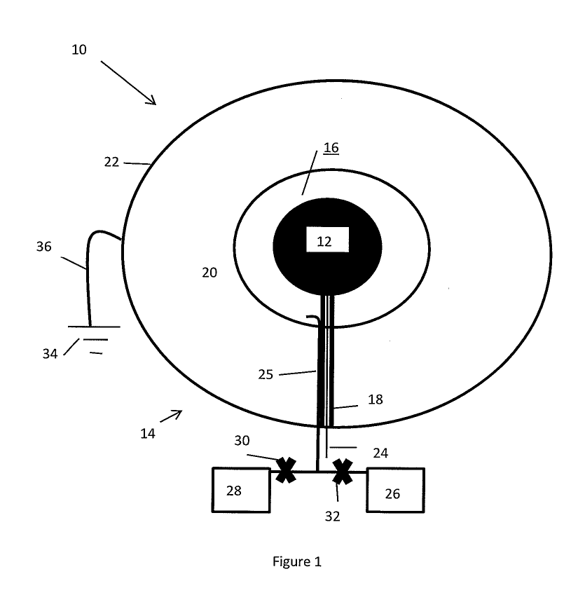

FIG. 1 illustrates a device according to the present invention for fusion of light nuclei. As shown, the device 10 includes a spherical electrode 12 centered within a hollow spherical shell 14. The shell 14 encloses an inner space 16 coaxially centered about the spherical electrode 12. An electrically insulated support 18 fixedly suspends the spherical electrode 12 within the spherical shell 14. A confinement layer 20, made of a high dielectric strength and high dielectric constant dielectric material, is located between the inner space 16 and the innermost surface of the spherical shell 14. A fusion reactive fuel such as deuterium gas is typically contained within the inner space 16, between the confinement layer 20 and the electrode 12. There is an electrically conductive insert 24 passing through the interior of the insulated support 18 which connects the spherical electrode 12 to a high voltage electric power source capable of imposing alternating electric potentials of various wave shapes with and without direct current offset (not shown). Alternatively, the wire 24 in the support stalk 18 could be connected to ground. To allow for supply of gas at low pressures to the inner space 16, there is a passage 25 also made up of non-conducting material that branches out to a T, one side of which leads to the gas supply system 28 which includes vacuum measurement gauges through the valve 30 while the other side leads to the vacuum pump system 26 through valve 32. Both valves 30 and 32 are made up of non-conducting material. There could be additional valves on the passage 25 for better control of flow of gases (not shown) and there could be expanded sections on it (not shown) especially on the branch leading to the vacuum pump system 26 that would help in control of pressures in the system when vacuuming.

The insulated support 18 holds the central spherical electrode 12 in place and can be made of such insulating material as fused alumina or any other insulating material capable of withstanding the generated heat and the generated electric fields without breakdown.

The confinement layer 20 is typically made of a non-conductive dielectric material with high dielectric strength and a high dielectric constant, i.e. high capacitance charging factor. The outermost lining 26 is typically metallic, encloses the confinement and reaction layer 20, and is connected to electric ground 34 by a wire 36, as shown. Thus, electrical interconnections are present between an electric power source leading to the insulated support 18, the spherical electrode 12, and earth ground 34. The metallic outermost shell 26, in addition to its function as a plate of a capacitor formed between it and the ions gathered on the inner surface of confinement layer 20, also acts as heat exchange medium between the device 10 and the outside environment. As such, it is envisioned that the device 10 of the invention can be placed in a water container or tank for generation of steam which can power a turbine.

The spherical shape is just one representative shape for the apparatus of the present invention. The spherical shape optimally allows for all the features (confinement and collision) required to accomplish the method of the invention. However, any shape that forms a confined space made up of a container made up of high dielectric charging factor material, allowing an electrode that might be metallic and bare and/or could be covered by a high dielectric charging factor material to come in contact with the gas fusion fuel can also work. As a non-limiting example, the electrode and shell and inner planes can be cylindrical, doughnut-shaped, or any other shape compatible with the intended purpose of the invention. The principals explained herein are applicable to many enclosed shapes made of dielectric material forming a confined space and allowing for an electrode that might be metallic and bare and/or could be covered by a high dielectric constant material and could have any shape compatible with the requirement of such designs to come in contact with the gas fuel, including cylindrical shapes or even parallel plate arrangement, in accordance with teachings of the invention.

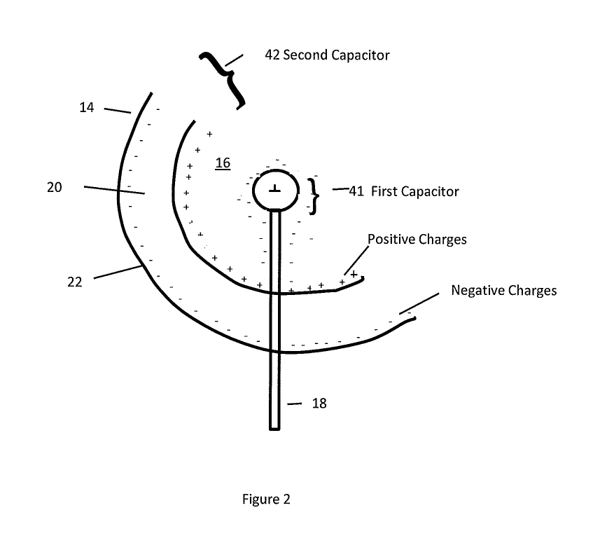

In one embodiment, illustrated in FIG. 2, the inner space 16 can be filled with deuterium gas as the fusion reactive fuel, and the spherical electrode 12 can be a metallic electrode covered by a high dielectric constant dielectric material. In this arrangement, if the electrode 12 is energized by a positive voltage, then there will be a build-up of an electrical field within the space 16. This mobilized electric field, if high enough, and depending on the pressure of the gas, could lead to the ionization of the gas in space 16 that would result in collection of electrons resulting from the splitting of the neutral atoms and molecules of the gas, on the surface of electrode 12 dielectric cover and repulsion of the hydrogen or deuterium atom nuclei (ions) to the inner edge of dielectric layer 20. This results in the formation of two capacitors in series. The first of these capacitors, referred to as the inner internal capacitor 41 having a capacitance of “C1”, is formed between electrode 12 and the electrons. Simultaneously there would be a second capacitor, referred to as the outer internal capacitor 42 with capacitance of “C2”, which is formed by the ions collected on and in close proximity to the confinement layer 20 and the induced negative charges on the inner surface of the metallic outermost shell 22. The amount of charge (electrons) moved onto the central electrode 12 is governed by the equivalent capacitance of the two capacitors thus formed as they are charged and are connected to each other in series through the gas that at the time of charging of these capacitors will be a conductor of electricity. The formation of the outer internal capacitor 42 will result in two phenomena. First it allows for higher concentration of ions on the inner surface of the confinement layer 20 as compared with the case that there would be no metallic shell 22. Further, it helps and facilitates the establishment of the electric field generated by the ions accumulated on the inner surface of the confinement layer 20 towards the shell and outside. Here it is noted that formation of the outer internal capacitor even if viewed as a capacitor only, would help reduce and eliminate any electric fields towards the interior of the inner space 16. But, if the ion layer formed on the inner surface of the inner space 16 forms a conductive ion layer, the elimination of the electric fields towards the interior of the inner space 16 will be more complete. In another embodiment of the invention, the inner space 16 of FIG. 1 can be filled with an elemental gas such as hydrogen or deuterium gas, and electrode 12 can be a metallic, low capacity electrode. For this case, and assuming the diameter of electrode 12 to be 2.5 centimeters, and the diameter of the inner space 16 to be 5.0 centimeters, and depending on the pressure of the gas in space 16 (assumed to be between 1.0 Torr and 150 milli-torr, and one Torr is equal to 133.32 Pascals), by application of a positive potential between 1500 and 2500 Volts, the potential difference between electrode 12 and ground, the gas surrounding it will ionize, as experimentally observed by this inventor, in many cases to more than 70% of the voltage applied to the electrode. This process can cause electrons of the ionized deuterium atoms to be absorbed by the central electrode 12, and the repulsion of the positively charged nuclei of the same atoms to the outer edge of the inner space 16 and onto the inner surface of the confinement layer 20 when the applied potential is high enough to cause sufficient ionization of the gas in space 16 and breakdown of this gas dielectric. Under this condition, and with application of potentials exceeding 1500 to 2500 Volts, there will be a positive ion concentration formed at the confinement layer 20 forming a first plate of the outer internal capacitor 42, the second plate being the induced charges on the inner surface of outermost shell 22, with layer 20 acting as the dielectric between these two capacitor plates. It is also noted that ionization of fuel gas could also occur at lower voltages, if the surface of electrode 12 is coated with a catalyst such as platinum black.

With this configuration, as a potential difference beyond the ionization potential of the deuterium gas is applied to electrode 12, the outer internal capacitor 42 formed at the confinement layer 20, having a capacitance approximated by Equation 10, will in time be charged to a potential differing from the potential applied to electrode 12 only by the potential required to break the dielectric strength of the gas in space 16, as this electrode will no longer act as a capacitor and will be a resistive element in this circuit.

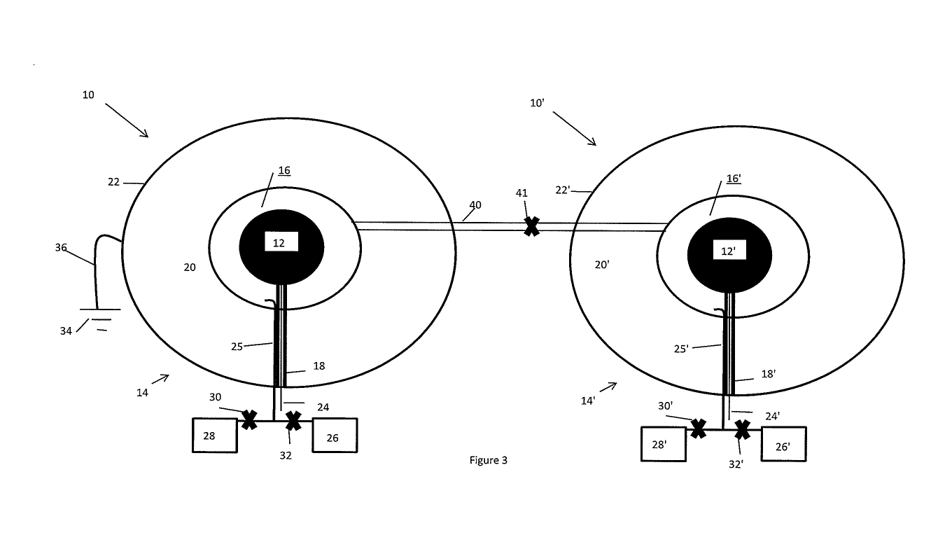

In yet another embodiment as illustrated in FIG. 3, there are two rather similar cells as in FIG. 1, with the parts for the second cell identified with a prime (′), that are the same as the parts identified on FIG. 1. In this figure the shell 22′ of the second cell is not grounded (is electrically floating). The electrode 12′ in the second cell 10′ is metallic and the electrode 12 in the first cell 10 is metallic and is covered by a high dielectric constant dielectric material, thus forming a capacitive electrode. In this configuration there is also a passage 40 positioned between the edge of the inner space 16 of the first cell and the edge of the inner space 16′ of the second cell, as shown. Passage 40 that could simply be a tube made of non-conductive material such as glass and is also equipped with a valve 41, also made up of non-conductive material that could be opened to allow gas and/or charge flow between the two inner spaces 16 and 16′. In this illustration if the shell 22 is grounded and the valve 41 on passage 40 is opened and the metallic electrode 12′ in the second cell 10′ is charged through wire 24 by connecting it to such a positive potential as to ionize the gas in its inner space 16′, the electrons generated by ionizing the gas will be absorbed by electrode 12′ and positive ions generated will flow to the outer edge of the inner space 16 and will form an ionic layer on the inner surface of the dielectric 20′ constituting a capacitor with the shell 22′. However, as the shell 22′ is not grounded, the capacitance of the outer inner capacitor there will be much smaller and the amount of charge transferred to the vicinity of the inner surface of the confinement layer 20′ will be less. Now if the shell 22 and the electrode 12 are grounded, when the valve 41 on the passage 40 is opened, and while the electrode 12′ is still connected to high voltage supply, the positive charges on the dielectric 20′ and additional ions generated at electrode 12′ will be at a higher potential than the capacitive electrode 12 and the inner face of the dielectric 20. This will result in the tendency of ions in the second cell 10′ to flow into the space 16 of cell 10 and accumulate on the inner surface of dielectric 20 and the outer surface of capacitive electrode 12, forming an inner internal capacitor and an outer internal capacitor respectively. This way and depending of the capacitances of the capacitors formed, certain amount of positive charges will be absorbed on each of the thus formed capacitors. In this arrangement, once the valve 41 is closed the charges in the cell 10 will be conserved and could be manipulated, deposited on the inner surface of the confinement layer 20 and/or move back and forth from the electrode 12 to the inner surface of the confinement layer 20, as experimentally verified by this inventor.

Still looking at FIG. 3, if in addition to electrode 12′ of the second cell 10′, the electrode 12 of the first cell 10 is also metallic and if when charging the electrode 12′ of the second cell 10′, the electrode 12 of the first cell 10 is not grounded and is not connected to anything else (electrically floating), the charges transferred from cell 10′ through the passage 40 and the now open valve 41 would only charge the outer internal capacitor of the cell 10. If by necessity of the design the electrode 12 of the cell 10 is of such a small size as to create higher intensity electric fields for use for firing ions towards the inner surface of the confinement layer 20, this way and by the use of larger electrodes 12′, the formation of the ion layer (ion sheath) in cell 10 could be facilitated.

On a theoretical level, the phenomena of capacitive confinement of ions can also be understood to occur through the formation of “induced surface charges” in the dielectric. As noted earlier, when a solid dielectric is placed between the plates of a capacitor, the action of the electric field generated between these plates leads to polarization of the dielectric and a shift in the center of positive and negative charges in the dielectric, even though the whole dielectric remains electrically neutral. The result of this polarization at an atomic level leads to formation of dipole moments and establishment of an electric field within the material opposing the original electric field. This is equivalent to formation of what is called “induced surfaces charges” with opposite polarity with respect to the charges on the capacitor plate adjacent to them. The effect of formation of these induced surface charges of opposite polarity near the charges on the original capacitor plates is to lower the potential of the charges on the capacitor plate, allowing them to pack more closely. Therefore, each positively charged nucleus will be at a much lower energy level than it would otherwise be at the same concentration, if not positioned against a polarized dielectric. Given the close packing of ions on the surface of the confinement layer 20, positively charged nuclei will behave as if their charge is much lower as compared to the same when in free space. Based on the above, it could be concluded that the higher the dielectric strength and the higher the dielectric constant of the confinement layer material, resulting in higher capacitance for a given geometry, then the lower the potential energy of individual charges will be, resulting in closer packing at a given voltage. It is also noted that if the dielectric constant of the confinement layer changes from one point to the other, or if the confinement layer is made up of two or more dielectric material, each covering one part of it between the inner space and the outer shell, or if there are variations in inner surface texture or features of the confinement layer, in all these situations, the potential of the ion sheath would be the same, but the charge density would differ in accordance to the local capacitance. This is equivalent to a capacitor with two side by side dielectrics positioned between the plates or two capacitors of differing capacitance connected in parallel. In these conditions the potential difference between the two plates would be the same, but total charge and charge density would vary according to the capacitance of each individual capacitor. This means that if the high dielectric constant dielectric only covers a part of the surface of the confinement layer, and the remainder would be made up of a material that has a lower dielectric constant, the ion sheath formed will have uniform potential throughout, but will have differing charge densities dependent on local capacitance.

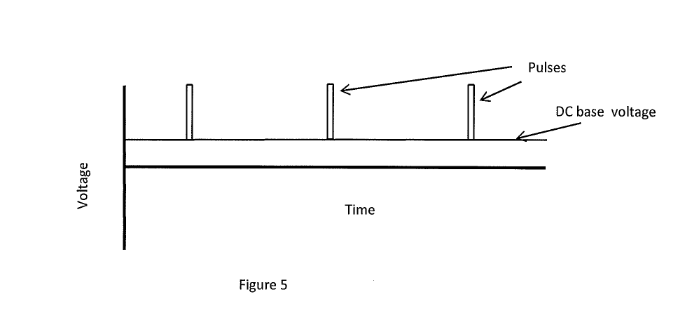

Given the above, and because capacitors are energy storing devices, it can also be postulated that kinetic energy can be imparted to individual positively charged nuclei, and these nuclei can then be “fired” or otherwise propelled towards nuclei restrained on the confinement layer. With the electric field generated by the charges on the inner surface of the confinement layer 20 being towards the outside of the inner space 16, the ions fired from the interior of the inner space 16 will be able to approach and fuse with the ions on the inner surface of the confinement layer 20. This is elimination of the coulomb barrier. In other words, when a certain amount of charges appear in the interior space (on the electrode or in the gas) their electric field will travel to the ions on the inner surface of the confinement layer with the speed of light. This increases the potential of the charges on the inner surface of the confinement layer and could result in some repositioning of these ions, re-establishing the elimination of the electric field to zero towards the interior. But, as these charges from the interior move towards the confinement layer, their induced electric field at the location of the surface of the confinement layer no longer changes (as moving away from the center, their potential drops). This means that as the ions propelled from the interior approach the confinement layer, the electric field induced by them at the surface of the confinement layer will remain constant. With the electric field generated by the ions on the inner surface of the confinement layer being outward in direction, and with the effect of the electric fields from the ions moving outward being constant at the location of the ions on the inner surface of the confinement layer, Coulomb repulsive forces preventing the approach of the two sets of ions would be minimized if not eliminated. That is, pulse charging and firing of positively charged nuclei from the electrode 12 or from the interior of the inner space 16 (by ionization of the gas particles there) towards the confined nuclei at the confinement layer 20 can lead to the penetration of the Coulomb barrier. See FIG. 5, which is a graph example showing pulses of high voltage that could be administered over time in order to generate and accelerate nuclei towards the confinement layer. Pulse charging of electrode 12 with very high voltages (only limited by the dielectric strength of the dielectric cover of this electrode, if used) beyond the voltages used to form high density charge distribution in and on the inner surface of the confinement layer 20 can be used as a means of accelerating positive ions from the surface of the interior of the cell towards the ions concentrated at the outer limits of the inner space 16. Pulse charging thus provides a means of penetrating the Coulomb Barrier by using the impact energy between ions.

It is important to note that, once the outer internal capacitor 42 is sufficiently charged, to such an extent that the ions deposited on it would form a conductive layer, usually referred to as an ion sheath, there will be no electric field generated towards the inner space 16 by charges at the confinement layer 20. Therefore, depending on the extent of the development of the ion sheath, charges on the confinement layer will generate progressively lower electric fields towards the interior of the inner space 16 (as also aided by formation of the outer internal capacitor there) and when fully developed as a conductive layer, allowing the ions to reposition themselves in response to any potential difference that might exist between them, will result in all such ions to have the same potential. This will result in the inner surface of the confinement layer 20 to constitute a charged conductor. It is a well-known fact in physics that there will be no electric field inside a charged conductor. As a result, and given the fact that the electric field generated by the ions on the inner surface of the confinement layer will be totally towards outside and there will be no component of the electric field towards interior of the inner space 16 from the charges on the inner surface of confinement layer 20, if additional ions are fired towards this ion sheath from the interior, the electric field from the positive charges in this ion sheath will not resist the nuclei fired at them from inside, such that no Coulomb repulsive forces will exist and thus there will be no Coulomb barrier to overcome for the fired ions approaching and getting to the ions on the said sheath. Stated differently, electrode 12 and the confinement layer 20 can constitute conditions of potentials as in a classical electrostatic generator, envisioned by Lord Kelvin and utilized as an accelerator or electro-static generator by R. J. Van de Graaff. As a result, when some amount of excess positive charges are generated at or placed on electrode 12 or otherwise are generated within the inner space 16, regardless of the amount of charges present on the inner surface of the confinement layer 20 or their potential, the potential of charges on electrode 12 will be higher than those on layer 20. Thus, if the dielectric strength of the gas in the inner space 16 is assumed to be a given amount denoted as “P”, when the potential applied to electrode 12 exceeds the value of “P” plus the value of the potential of the ion sheath on the inner surface of confinement layer 20 (please note that even with zero excess charge, the potential of the electrode in the inner space 16 will be equal to the potential of the ion sheath on the inner surface of the confinement layer 20, the potential in the interior of a charged conductor in all locations of the interior is the same as the potential of the charges on it- and therefore if there are any excess charges on or in the vicinity of this electrode, their potential at all times will be higher than the potential of the ions on the ion sheath), there would be a tendency for the excess charge generated or placed on electrode 12 to flow to layer 20. This tendency will exist irrespective of the potential of the ion sheath, as long as there is any excess charge on or in the vicinity of electrode 20.

It is noted that flow of charge in gases, is governed by a number of phenomena. If two electrodes of the same dimensions are placed at a distance apart with a gas filling the space between them, and if the potential difference between the two plates is increased, there comes a point that some electrons from the plate with lower potential will tend to fly towards the plate with higher potential or due to some external phenomena such a space rays some neutral gas molecules might ionize, releasing an electron and a positive ion. Depending on the pressure controlling the number of gas particles between the plates, the flying electrons and/or the positive ions moving in the imposed electric field could collide with neutral gas particles and if the energy of these charged particles is high enough to ionize the neutral gas particles by impact ionization, a number of additional neutral particles would ionize, releasing positive ions and additional electrons. If the intensity of the electric field is high enough this phenomenon continues in what is usually referred to as avalanche formation and could progress to such a point that sufficient ionized particles would exist between the plates to constitute a conductive path between them. This way an appreciable current will flow between the plates and could be viewed as a spark. This light emission seen as a spark is the result of high energy collusion of ions with gas particles, resulting in a drop in the kinetic energy of the flying ions with the difference in before and after collusion kinetic energy of the flying ion coming out as photons (light). This process is used in florescent lamps to generate light. This is explained in the so called Paschen's law that relates the voltage applied between two flat metallic plates facing each other to gas pressure and the distance between the two plates for a given gas. So, if the length that a given size charged particle could fly in gas before hitting other gas particles, is longer than the distance between the said plates, no avalanche could form and there would be no conductive path formed between the plates. The length that a moving particle could fly without hitting other particles is called Mean Free Path (MFP) and is usually calculated based on particle size, gas pressure and temperature using Serway's approach.

In the embodiments shown on FIG. 1 and FIG. 3 it would be desirable to generate ions and have them deposited as an ion sheath on the inner surface of the confinement layer 20. As some impact between ions and gas particles would not hamper this operation, this could be done at any suitable gas pressure. We further want additional ions to be generated from the interior and fly from the interior of inner space 16 to towards the ion sheath. This will then require the pressure in the inner space 16 to be such that the Mean Free Path for these flying ions will be longer than the length of their flight path. Further, if the pressure suitable for ionization of the gas in the inner space 16 of cell 10 or the pressure suitable for transfer of charges from cell 10′ to cell 10 is higher that the pressure needed to allow for firing and unobstructed flight of generated ions in cell 10, the section of the passage between valve 32 and vacuum pump 26 could be fully vacuumed to pressures lower than about 1 to 5 milli-Torr. This condition will increase the electrical resistance of this section of the passage 25 to such an extent that if the valve 32 is gradually opened while the vacuum pump is still running, the gas pressure in the inner space 16 could be lowered without the risk of an electric discharge of the ions there in to the typically grounded vacuum pump system.

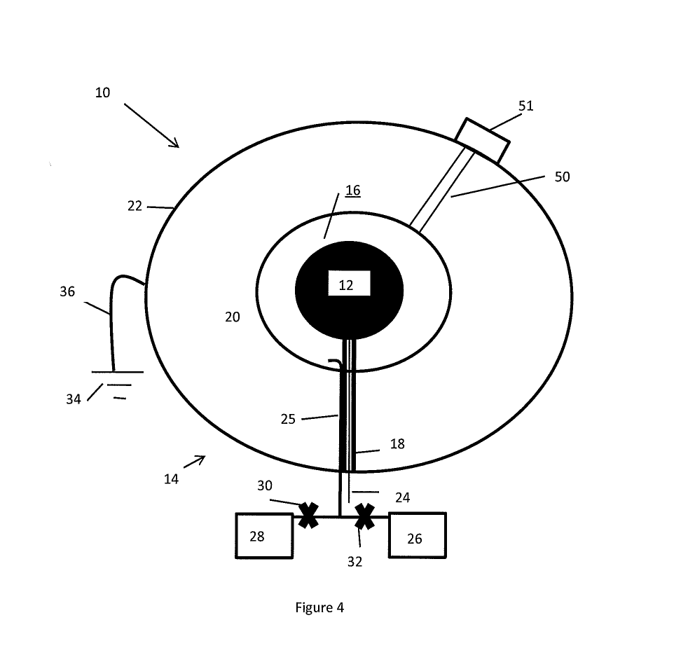

Another embodiment of this invention is schematically illustrated on FIG. 4. In this figure all numerals are the same and identify the same parts as in FIG. 1, with added passage 50 incorporated in the confinement layer 20 leading from the inner space 16 to a source of ionizing radiation 51. This source of ionizing radiation could be a source such as an extreme ultraviolet light lamp (photon energy in the order of few hundred electron volts). Such ionizing radiation that could also be a strong alpha particle or similar sources could be used to direct ionizing radiation to the inner space 16 and the fuel gas therein through passage 50. Formation of ionized gas particles by the use of ionizing radiation of high enough intensity to impact the low pressure gas that would exist in the inner space 16 at the time that it is desired to fire ions, would facilitated formation of the needed ions and will reduce the intensity of the electric fields needed to ionize that gas and cause the accelerated flight of the charged particles to that needed just to accelerate the charged particles resulting from already ionized gas.

Particle interaction and fusion reaction considerations in this invention are as follows; when two positively charge nuclei approach each other in free space, the probability of fusion between them is usually defined in terms of interaction cross section which is an equivalent way of designating this interaction probability. For deuteron-deuteron (D-D) fusion reaction the typical cited interaction cross sections for particle energies ranging from 1000 electron volts to 20000 electron volts range from 5.6E−18 barns to 2.77E−04 Barns (1.0 Barn is equal to 1E−28 m2). Such numbers then increase to 0.064 Barns at 400,000 electron volts particle energy. The increase in the interaction cross section as function of particle energy relates to the probability of overcoming the coulomb barrier. This is why the typical interaction cross section for a neutron that has nearly the same at rest size and the same mass and has no charge is much higher. The typical neutron capture cross section for hydrogen nuclei is usually cited as being in the order of 0.33 Barns for lower energy neutrons. This indicates the effect of the coulomb barrier that when the coulomb interactions are absent, the probability of a direct hit is more (larger interaction cross sections).

When as proposed in this document the coulomb barrier is highly reduced or eliminated, it could logically be expected that the interaction cross section would increase. One means of estimating such cross sections is by the use of the De Broglie wave length. The square to the De Broglie wave length as the interaction cross section for the condition of elimination of the coulomb barrier, assuming kinetic energies in the order of 1500 electron Volts for interaction of the ions fired from the interior of the inner space 16 towards the ion sheath yield a square of de Broglie wave length in the order of 5.45E−25 m2 which is equivalent to 5450 Barns.

If a confinement layer has a dielectric constant of 2000 and a sufficiently large dielectric strength and is charged to a charge density of about 3.5E−03 Coulombs per square meters, the individual charge particle density would be about 2.2E+16 ions per square meters. Assuming that the individual ions would each have an interaction cross section of 5.45E−25 m2 for particle energy of 1500 electron volts, this yields an area of almost 1.2E−08 m2 covered by such ions per m2 of the confinement layer surface. This means that if 8.33E+07 (=1/1.2E−08) ions are fired towards such ion sheath, there could be one hit. If the current of the ions fired towards such a sheath would be about 0.1 mA equivalent to 6.25E+14 ions being fired per second, then based on the probability of hits noted above, there could be 7.5E+6 hits. Noting that for D-D fusion reactions it is usually assumed that one neutron is generated per two fusion interaction (due to branching of this reaction to tritium and proton products and helium and neutron products, producing reactions each with the probability of 50%) , the above calculation results in an expect neutron production rate of 3.75E+06 neutrons per second. With higher density of charges in the target ion sheath and with higher intensity of ion currents generated, these rates of reactions would increase. If the energy input for fired ions is also reduced, then it is expected that yields (energy output/energy input) would be raised to more than unity.

While the present invention has been illustrated by the description of embodiments and examples thereof, it is not intended to restrict or in any way limit the scope of the appended claims to such detail. Additional advantages and modifications will be readily apparent to those persons of ordinary skill in the art. Accordingly, departures may be made from such details without departing from the scope of the invention.

What is claimed is:

1. An apparatus for penetrating the Coulomb Barrier, comprising:
a) an electrode;
b) a hollow shell enclosing an inner space around the electrode;
c) a confinement layer made of a material having a high dielectric strength and a high dielectric constant, the confinement layer located on the inside surface of the hollow shell, the inner space located between the confinement layer and the electrode;
d) a fusion reactive fuel contained within the inner space;
e) a high voltage electric power source capable of imposing alternating electric potentials with various wave shapes with and without direct current offset;
f) electrical interconnections for connecting the electric power source to the electrode and for connecting the hollow shell to earth ground;
g) passages for directing the fusion reactive fuel into and out of the hollow shell;
h) a fusion reactive fuel supply system; and
i) a vacuum pump system comprising vacuum measurement gauges.

2. The apparatus of claim 1, wherein the electrode is in the form of a thin wire.

3. The apparatus of claim 1, wherein the electrode is metallic.

4. The apparatus of claim 1, wherein the electrode is a capacitive electrode covered with a high dielectric constant material.

5. The apparatus of claim 1, wherein the electrode and the hollow shell are both metallic and spherical, the electrode being centered within the hollow shell.

6. The apparatus of claim 5, further comprising an electrically insulated support fixedly suspending the electrode within the shell.

7. The apparatus of claim 1, wherein the electrode is composed of low capacitance material.

8. The apparatus of claim 1, wherein the fusion reactive fuel gas is at a predetermined pressure such that the Mean Free Path for the gas would be longer than the distance between the electrode and the confinement layer.

9. A method of confining and firing upon nuclei for the purpose of reducing or eliminating the Coulomb barrier, the method comprising:
a) providing a confinement layer made of a material having a high dielectric strength and a high dielectric constant, the confinement layer located on the inside surface of a hollow shell, the hollow shell enclosing an inner space around an electrode, the inner space located between the confinement layer and the electrode;
b) filling the inner space with a fusion reactive fuel;
c) charging an electrode seated within the inner space with a high voltage electric power source capable of imposing alternating electric potentials with various wave shapes with and without direct current offset, wherein the hollow shell both encloses the inner space and is centered about the electrode, and wherein charging of the electrode causes a cloud of positively charged nuclei to form on the confinement layer; and
d) firing other charged nuclei at the cloud of positively charged nuclei on the confinement layer, wherein the other charged nuclei are generated and propelled towards the confinement layer by an electric field generated by the charged electrode.

10. The method of claim 9, further comprising repeated pulse charging of the electrode with high voltage.

11. The method of claim 9, further comprising ionizing the gas content of the inner space by emission of ionizing radiation into the inner space, the ionizing radiation produced by an ionizing radiation source comprising high energy photon sources.

12. An apparatus for generation and capacitive confinement of charged nuclei as a means of overcoming the Coulomb Barrier, comprising:
a) a metallic electrode;
b) a multi-layered, hollow, metallic shell enclosing an inner space around the electrode, wherein the shell includes a confinement layer made of a material having a high dielectric strength and a high dielectric constant, the confinement layer located on the inside surface of the shell, the inner space located between the confinement layer and the electrode;
c) an electrically insulated support fixedly suspending the electrode within the shell;
d) a fusion reactive fuel contained within the inner space;
e) a high voltage electric power source capable of imposing alternating electric potentials with various wave shapes with and without direct current offset;
f) electrical interconnections for connecting the electric power source to the electrode and the shell to the earth ground;
g) at least one passage for directing the fusion reactive fuel into and out of the hollow shell;
h) at least one passage for directing ionizing radiation into the inner space;
i) an ionizing radiation source for each of the at least one ionizing radiation passage;
j) a fusion reactive fuel supply system; and
k) a vacuum pump system comprising vacuum measurement gauges.

13. The apparatus of claim 12, wherein the electrode is in the form of a thin wire.

14. The apparatus of claim 12, wherein the electrode is a capacitive electrode covered with a high dielectric constant material.

15. The apparatus of claim 12, wherein the electrode and the hollow shell are both spherical, with the electrode being centered within the hollow shell.
